(19) United States
(12) Patent Application Publication
(10) Pub. No.: US 2005/0240609 A1
(43) Pub. Date: Oct. 27, 2005

(54) Method and apparatus for setting storage groups

(76) Inventors: Jun Mizuno, Yokohama (JP); Takeshi Ishizaki, Yokohama (JP); Kiminori Sugauchi, Yokohama (JP); Atsushi Ueoka, Yokohama (JP); Emiko Kobayashi, Yokohama (JP); Toui Miyawaki, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/892,213

(22) Filed: Jul. 16, 2004

(30) Foreign Application Priority Data
Apr. 27, 2004 (JP) 2004-131242

(51) Int. Cl. G06F 17/00

(52) U.S. Cl. 707/101

(57) ABSTRACT

Storage groups are generated using group information previously set to a switch 3.

In a group information acquisition step, group information, which is previously set to the switch 3 and relates to computers 4 and storage devices 5, is acquired from the switch 3, and the acquired group information is stored in a storing means 16. In a node information acquisition step, node information required for connecting to a network is acquired from each of the computers 4 and the storage devices 5, and acquired node information is stored in the storing means 16. In a group generation step, the storage groups are generated based on the group information stored in the storing means 16. And, in a registration step, the generated storage groups and the node information stored in the storing means 16 are registered at a storage name solving server 2.

This application claims a priority based on Japanese Patent Application No. 2004-131242 filed on Apr. 27, 2004, the entire contents of which are incorporated herein by reference for all purpose.

### FIELD OF THE INVENTION

The present invention relates to a technique of setting storage groups in a storage area network.

### BACKGROUND OF THE INVENTION

Technique of connecting computers and storage devices is changing from FC-SAN (Storage Area Network) using Fibre Channel to IP-SAN using an IP network such as iSCSI (Internet Small Computer Systems Interface) or iFCP (Internet Fibre Channel Protocol).

Further, sometimes in FC-SAN and IP-SAN, nodes such as computers and storage devices are classified into groups to limit computers that can access storage devices. For example, U.S. Patent Application Publication No. 2003/0085914 (herein after, referred to as “Patent document 1”) describes use of a technique called zoning in FC-SAN for managing nodes by classifying the nodes into groups each called a zone.

To designate a node as a destination of connection, a node such as a computer or a storage device should find nodes that can be connected to itself. In the case of a small-scale IP-SAN, an administrator can manually set and manage nodes that can be connected. However, in a large-scale IP-SAN, manual management is difficult. Thus, in a large-scale IP-SAN, an iSNS (Internet Storage Name Service) server or the like is used to find nodes. And, as a method of finding nodes, there is a method in which nodes are classified into some storage groups, and, when a node finding request is issued, nodes are found only from nodes belonging to the same storage group as the node that has issued the finding request belongs to.

In the case where storage groups are employed, then how to generate the storage groups is a problem. For example, it is undesirable from the viewpoint of security that a storage device can be accessed from all the computers. In the patent document 1, an administrator manually defines storage groups through an input device, based on information displayed on a display means. As a result, there occur problems of heavy work load and mistake in defining the storage groups since the administrator manually defines the storage groups.

### SUMMARY OF THE INVENTION

The present invention has been made considering the above conditions, and an object of the present invention is to generate storage groups, using group information previously set to each network device.

To solve the above-described problems, an information processing device in the present invention uses group information previously set to each network device, in order to generate storage groups.

For example, an arithmetic means of the information processing device performs: a group information acquisition step in which group information for identifying a group to which a node belongs is acquired from each network device previously set with that group information and the acquired group information is stored in a storing means owned by the information processing device; a node information acquisition step in which, for each node, node information required for connecting that node to the network is acquired from that node and the acquired node information is stored in the above-mentioned storing means; a group generation step in which storage groups are generated based on the group information stored in the above-mentioned storing means; and a registration step in which the generated storage groups and the node information stored in the above-mentioned storing means are registered at a management server.

According to the present invention, it is possible to generate storage groups, using group information previously set to each network device.

### BRIEF DESCRIPTION OF THE DRAWINGS

FIG. 1 is a schematic diagram showing a storage management system to which a first embodiment of the present invention is applied;

FIG. 2 is a diagram showing an example of a hardware configuration of a storage group registration server or the like;

FIG. 3 is an outline flowchart of a storage group registration server;

FIG. 4 is a flowchart of a switch information acquisition unit;

FIG. 5 is a diagram showing an example of a management object switch table;

FIG. 6 shows an example of switch information acquisition request transfer information;

FIG. 7 shows an example of switch registration information;

FIG. 8 shows an example of switch information acquisition response transfer information;

FIG. 9 is a diagram showing an example of a switch information table;

FIG. 10 is a flowchart for a node information acquisition unit and a group generation unit;

FIG. 11 shows an example of node information acquisition request transfer information;

FIG. 12 shows an example of node information acquisition response transfer information;

FIG. 13 is a diagram showing an example of a group information table;

FIG. 14 is a diagram showing an example of a storage management information table;

FIG. 15 is a flowchart for a storage name registration unit;

FIG. 16 shows an example of storage group transfer information;

FIG. 17 shows an example of node information transfer information;

FIG. 18 is a diagram showing an example of a storage group name management table;

FIG. 19 is a diagram showing an example of a storage name solving table;

FIG. 20 is a schematic diagram showing a storage management system to which a second embodiment of the present invention is applied;

FIG. 21 shows an example of status change notification transfer information;

FIG. 22 is an outline flowchart for a storage group registration server;

FIG. 23 is a flowchart for a status change notification receiving unit;

FIG. 24 is a diagram showing an example of a status change notification preserving table; and

FIG. 25 is a flowchart for a node information acquisition unit.

### DESCRIPTION OF THE PREFERRED EMBODIMENT

Now, embodiments of the present invention will be described.

### First Embodiment

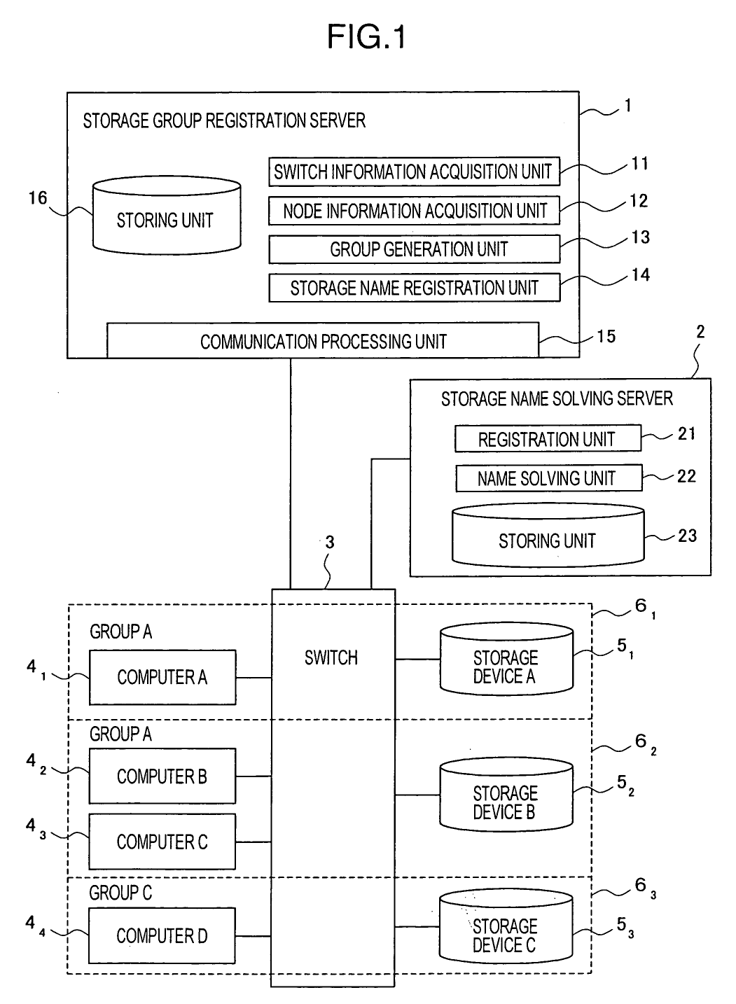

FIG. 1 is a schematic diagram showing a storage management system to which a first embodiment of the present invention is applied. As shown in the figure, the storage management system of the present embodiment comprises a storage group registration server 1, a storage name solving server 2, one or more computers 4₁-4₄, one or more storage devices 5₁-5₃, and one or more switches 3. Using the switches 3, these components are connected to an IP network such as Internet. Hereinafter, each of the computers 4 and storage devices 5 connected to the switches 3 is referred to as a node.

Each switch 3 is a network device that performs path control using IP addresses and exercises a routing function for transferring data to an output port corresponding to a target IP address. In the present embodiment, it is assumed that each switch 3 is previously set with at least one VLAN (Virtual Local Area Network) based on a MAC address. VLAN is a virtual LAN in which nodes such as computers 4 and storage devices 5 are virtually grouped independently of a physical connection. By setting VLANs to a switch 3, it is possible to limit computers 4 that can access each storage device 5. Namely, after setting the VLANs, only nodes set with the same VLANID (identification information for identifying a VLAN) can communicate with one another, while nodes set with different VLANIDs can not access each other. Each switch 3 has switch registration information, i.e., VLAN setting information described below, to classify nodes connected to the switch 3 into groups, and data is sent only within a group concerned. In the example shown in FIG. 1, a group A 6₁ includes a computer A 4₁ and a storage device A 5₁. A group B 6₂ includes a computer B 4₂, a computer C 4₃ and a storage device B 5₂. Further, a group C 6₃ includes a computer D 4₄ and a storage device C 5₃.

Here, as a VLAN, may be mentioned a MAC address-based VLAN in which a group is defined for each MAC address, a port-based VLAN in which a group is defined for each port of the switch 3, or a protocol-based VLAN in which a group is defined for each protocol, for example.

The storage group registration server 1 acquires switch registration information, i.e., VLAN setting information, from a switch 3, and acquires node information from each node such as a computer 4 or a storage device 5 connected to the switch 3. Node information is, for example, a port number or an IP address, i.e., information required for connecting to the network. The storage group registration server 1 generates group information of a storage group and registers the generated group information and node information at the storage name solving server 2. Here, the group information is information that associates a group of each previously-set VLAN with a storage group.

The storage group registration server 1 comprises a switch information acquisition unit 11, a node information acquisition unit 12, a group generation unit 13, a storage name registration unit 14, a communication processing unit 15, and a storing unit 16. The switch information acquisition unit 11 acquires switch registration information as setting information of VLANs from each switch 3 managed by its storage group registration server 1. The node information acquisition unit 12 acquires node information from the computers 4 and the storage devices 5. The group generation unit 13 generates group information based on the switch registration information and the node information. The storage name registration unit 14 registers the generated group information and the node information at the storage name solving server 2. The communication processing unit 15 sends and receives data to and from another apparatus through the network. The storing unit 16 stores a setting file and the below-mentioned various tables. The setting file includes the IP address of each switch 3 managed by the storage group registration server 1 and the IP address of the storage name solving server 2.

The storage name solving server 2 registers the group information generated by the storage group registration server 1 and finds a node based on the group information. As shown in the figure, the storage name solving server 2 comprises a registration unit 21, a name solving unit 22, and a storing unit 23. The registration unit 21 receives the group information generated by the storage group registration server 1 and the node information and registers the received information at the storing unit 23. When the name solving unit 22 receives a request for finding a node from a computer 4, the name solving unit 22 finds a storage device 5 existing in the same group as the computer 4 from which the request is received belongs to. For example, in the storage management system shown in FIG. 1, when a request for finding a node is received from the computer A 4₁, then the name solving unit 22 refers to the below-mentioned storage name solving table stored in the storing unit 23, to find the storage device A 5₁ that belongs to the same group A 6₁ as the computer A 4₁ belongs to. The storing unit 23 stores the below-mentioned storage group name management table and the storage name solving table.

The storage management system of the present embodiment has the storage group registration server 1 and the storage name solving server 2 separately. However, it is possible that the storage group registration server 1 has the functions of the storage name solving server 2.

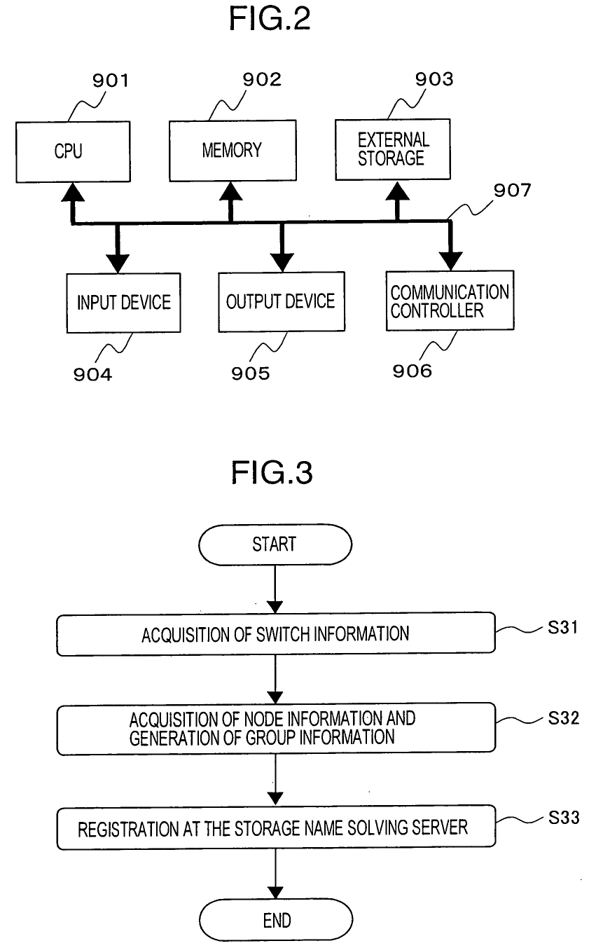

Each of the storage group registration server 1, the storage name solving server 2 and the computers 4 described above may be implemented by a general purpose computer system comprising, for example as shown in FIG. 2, a CPU 901, a memory 902 such as a RAM, a external storage 903 such as a HDD, an input device 904 such as a keyboard and/or a mouse, an output device 905 such as a display and/or a printer, a communication controller 906 for connection to a network, and a bus 907 for connecting the above-mentioned components with one another. Each function of the above-mentioned servers 1 and 2 and the computers 4 is realized when the CPU 901 executes a certain program loaded on the memory 902.

For example, each functions of the storage group registration server 1, the storage name solving server 2 and the computers 4 is realized when the CPU 901 of the storage group registration server 1 executes a program of the storage group registration server, the CPU 901 of the storage name solving server 2 executes a program of the storage name solving server 2, or the CPU 901 of a computer executes a program of a computer 4. Further, as the storing unit 16 of the storage group registration server 1, is used the memory 902 or the external storage 903 of the storage group registration server 1. Further, as the storing unit 23 of the storage name solving server 2, is used the memory 902 or the external storage 903 of the storage name solving server 2.

Next, will be described an outline of processing in the storage group registration server 1.

FIG. 3 is a flowchart showing operation of a storage group registration server. First, the switch information acquisition unit 11 acquires switch information (VLAN setting information) included in the switch registration information from every switch 3 under management (S31). Then, the node information acquisition unit 12 acquires the node information of nodes (computers 4 and storage devices 5) included in the acquired switch information. Then, based on the switch information and the node information, the group generation unit 13 generates group information whose grouping is same as the grouping of VLANs previously set for each switch 3 (S32). The storage name registration unit 14 registers the generated group information and the node information at the storage name solving server 2 (S33).

Next, the switch information acquisition processing (S31 of FIG. 3) will be described in detail.

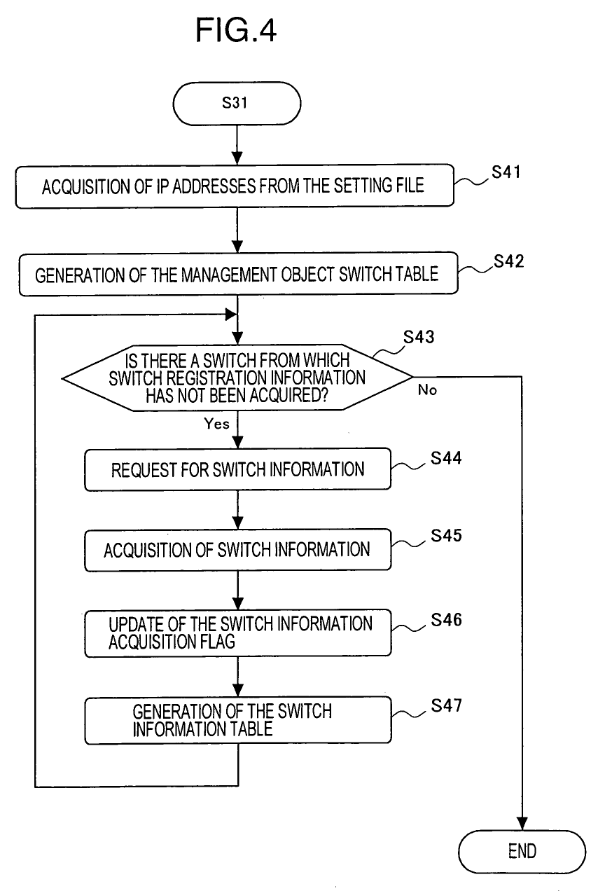

FIG. 4 is a flowchart showing the switch information acquisition processing. First, the switch information acquisition unit 11 reads the setting file stored previously in the storing unit 16 to acquire IP addresses (which are stored in the setting file) of the switches 3 under management (S41). Then, the switch information acquisition unit 11 generates a management object switch table and stores the generated table into the storing unit 16 (S42).

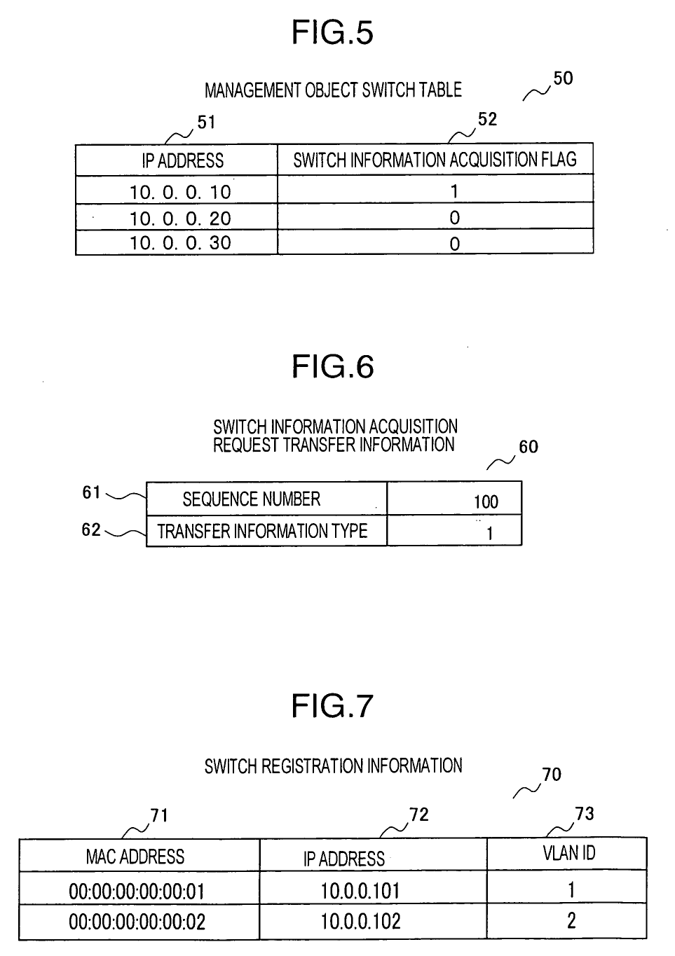

FIG. 5 is a diagram showing an example of the management object switch table 50. As shown in the figure, the management object switch table 50 includes an IP address 51 (which is acquired from the setting file) of a switch 3 and switch information acquisition flag 52 corresponding to that IP address 51. The switch information acquisition flag 52 is a flag indicating a status of acquisition of switch information. The switch information acquisition unit 11 sets “0” (not yet acquired) to all the switch information acquisition flags 52, at the time of generating the management object switch table (S42). When switch information is acquired according to the below-described processing, then the switch information acquisition unit 11 updates the switch information acquisition flag 52 of the IP address 51 corresponding to the acquired switch information to “1” (acquired).

Next, the switch information acquisition unit 11 reads the management object switch table 50 generated in S42 from the storing unit 16, to judge whether there exists an IP address 51 (a switch 3) whose switch information has not been acquired (S43). Namely, the switch information acquisition unit 11 refers to the switch information acquisition flags 52 in the management object switch table 50 to judge whether there exists an IP address 51 whose switch information acquisition flag 52 is “0” (not yet acquired). In the case where there exists an IP address 51 whose switch information has not been acquired yet (YES in S43), then the switch information acquisition unit 11 sends switch information acquisition request transfer information to the switch 3 at the IP address 51 in question for acquiring the switch information (S44).

FIG. 6 shows an example of a switch information acquisition request transfer information 60. As shown in the figure, the switch information acquisition request transfer information 60 includes a sequence number 61 and a transfer information type 62. The sequence number 61 is a unique identification number for identifying the switch information acquisition request transfer information 60. Further, the transfer information type 62 indicates whether the type of the transfer information is switch information request information or response information. The switch information acquisition unit 11 sets identification information (“1” in the present embodiment) indicating a switch information request, to the transfer information type 62.

Receiving the switch information acquisition request transfer information 60, the switch 3 generates switch information acquisition response transfer information 80 based on the switch registration information (See FIG. 7) stored in advance in the storing means of the switch 3, and sends the generated switch information acquisition response transfer information 80 to the storage registration server 1.

FIG. 7 shows an example of a switch registration information 70 held by each switch 3. For each node (a computer or a storage device 5) connected to the switch 3 in question, the switch registration information 70 includes a MAC address 71, an IP address 72 and a VLANID 73 of the node. The VLANID 73 is identification information for identifying a VLAN to which the node belongs. In the example shown in the figure, a node whose IP address 72 is “10.0.0.101” belongs to the VLAN whose VLANID 73 is “1”. Further, a node whose IP address 72 is “10.0.0.102” belongs to the VLAN whose VLANID 73 is “2”.

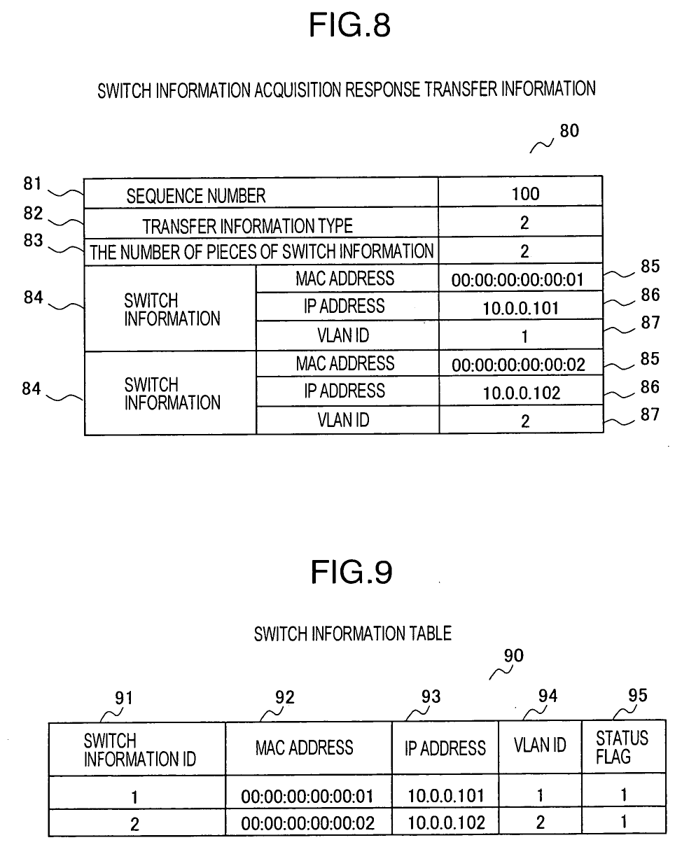

FIG. 8 shows an example of a switch information acquisition response transfer information 80. As shown in the figure, the switch information acquisition response transfer information 80 includes a sequence number 81, a transfer information type 82, the number of pieces of switch information 83, and at least one piece of switch information 84. The sequence number 81 is set with the same value as the sequence number 61 of the received switch information acquisition request transfer information 60. The transfer information type 82 is set with identification information (“2” in the present embodiment) indicating a response of switch information. The number of pieces of switch information 83 is set with the number of the nodes (computers 4 and storage devices 5) connected to the switch 3 in question. The switch counts the number of nodes (records) registered in the switch registration information 70 and sets the count to the number of pieces of switch information 83. Pieces of switch information 84 are prepared by the number (of the nodes) set in the number of pieces of switch information 83. Each piece of switch information 84 is set with the MAC address 85, the IP address 86 and the VLANID 87 of a node registered in the switch registration information 70.

The switch information acquisition unit 11 acquires (receives) such switch information acquisition response transfer information 80 from the switch 3 to which the switch information acquisition request transfer information has been sent (S45). Then the switch information acquisition unit 11 changes the switch information acquisition flag 52 of the processing object to “1” in the management object switch table 50 stored in the storing unit 16 (S46). Then, based on the acquired switch information acquisition response transfer information 80, the switch information acquisition unit 11 generates the below-mentioned switch information table 90 (See FIG. 9) and stores the generated switch information table 90 in the storing unit 16 (S47). Namely, the switch information acquisition unit 11 adds each piece of switch information 84 (each node) of the switch information acquisition response transfer information 80 to the switch information table 90. At that time, the switch information acquisition unit 11 discards a duplicate piece of switch information 84 without adding that piece to the switch information table 90. Namely, in the case where the same MAC address as the MAC address 85 of a piece of switch information 84 has been already stored in the switch information table 90, the switch information acquisition unit 11 does not add that piece of switch information 84 to the switch information table 90. As a case where a duplicate piece of switch information 84 exists, it is possible to consider a case where one node (corresponding to that piece of switch information 84) is connected to a plurality of switches 3.

FIG. 9 shows an example of a switch information table 90. A switch information table 90 includes, for each piece of switch information 84 (i.e., for each node) of the switch information acquisition response transfer information 80, a switch information ID 91 for identifying that piece of switch information 84, a MAC address 92, an IP address 93, a VLANID 94 and a status flag 95 indicating a processing status. The switch information ID 91 is unique identification information for identifying each piece of switch information 84 (node). In the present embodiment, the switch information acquisition unit 11 sets a sequential number in turn to the switch information ID 91. Further, the status flag 95 is set with one of values “0” indicating an initial state, “1” indicating that the node information has been already acquired, and “2” indicating that registration to the below-described storage management information table has been finished. When the switch information acquisition unit 11 adds a piece of switch information 84 to the switch information table 90 (S47), “0” (initial state) is set to the status flag 95. Further, the MAC address 92, the IP address 93 and the VLANID 94 are respectively set with the MAC address 85, the IP address 86 and the VLANID 87 set in the switch data 84 of the switch information acquisition response information 80.

After adding processing to the switch information table 90 (S47), the switch information acquisition unit 11 returns to the processing of S43 to judge whether there exists a switch 3 for which the processing of acquiring the switch registration information 70 has not been performed. In the case where there does not exist a switch 3 for which the processing of acquiring the switch registration information 70 has not been performed (NO in S43), then the switch information acquisition unit 11 ends the switch information acquisition processing (S31 of FIG. 3).

Next, the processing of acquiring the node information and generation of the group information (S32 of FIG. 3) will be described in detail.

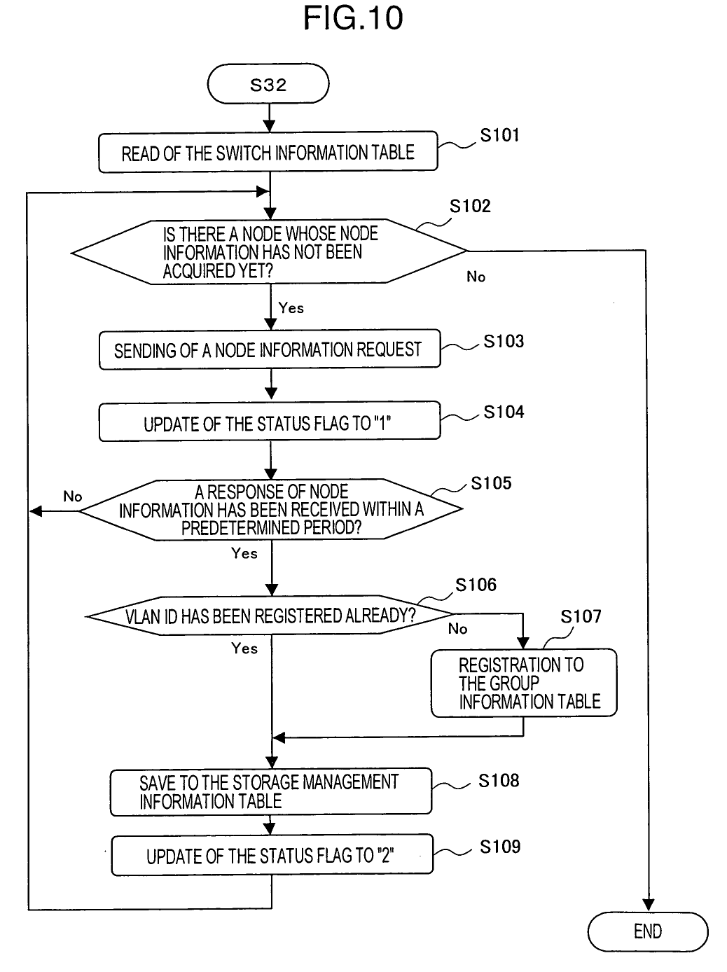

FIG. 10 is a flowchart showing the node information acquisition processing and the group information generation processing. First, the node information acquisition unit 12 reads the switch information table 90 generated by the switch information acquisition unit 11 from the storing unit 16 (S101). Then, the node information acquisition unit 12 refers to the status flags 95 in the switch information table 90 to judge whether there exists a piece of switch information for which processing of acquiring the node information has not been performed (S102). In other words, the node information acquisition unit 12 judges whether there exists a piece of switch information whose status flag 95 is set with “0” indicating an initial state.

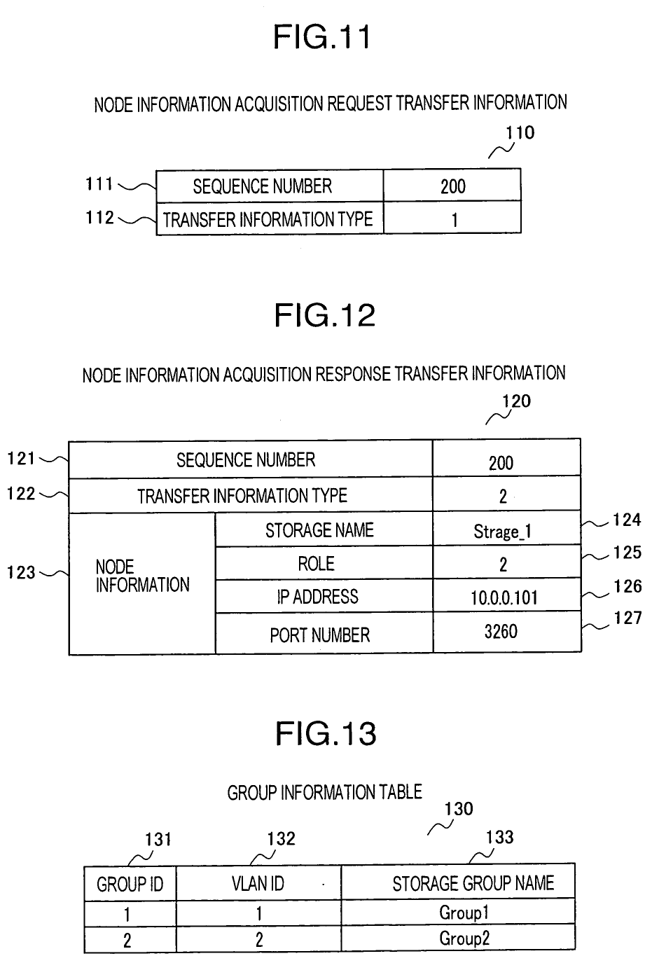

In the case where there exists a piece of switch information for which the node information has not been acquired (YES in S102), then the node information acquisition unit 12 sends the node information acquisition request transfer information 110 shown in FIG. 11 to the destination having the IP address 93 of the switch information in question through the switch 3, to request the node information (S103). The node information is information (such as a port number or an IP address) required for connecting to the network. After sending the node information acquisition request transfer information, the node information acquisition unit 12 changes the status flag 95 of the node in question in the switch information table 90 to “1” indicating that the node information has been acquired (S104). Here, the node information acquisition unit 12 is in a waiting state until a response is received from the node in question.

FIG. 11 shows an example of a node information acquisition request transfer information 110. As shown in the figure, the node information acquisition request transfer information 110 includes a sequence number 111 for identifying the node information acquisition request transfer information and a transfer information type 112 for identifying a type of the transfer information. The node information acquisition unit 12 sets identification information (“1” in the present embodiment) indicating that the transfer information is a request for the node information, to the transfer information type 112.

Each node (a computer 4 or a storage device 5) that receives the node information acquisition request transfer information 110 sends node information acquisition response transfer information 120 shown in FIG. 12 to the storage group registration server 1.

FIG. 12 shows an example of a node information acquisition response transfer information 120. As shown in the figure, the node information acquisition response transfer information 120 includes a sequence number 121, a transfer information type 122 and node information 123. The sequence number 121 is set with the same value as the sequence number 111 of the received node information acquisition request transfer information 110. The transfer information type 112 indicates whether the type of the transfer information is node information request information or response information. The node (a computer 4 or a storage device 5) sets identification information (“2” in the present embodiment) indicating a response of switch information. The node information 123 includes a storage name 124 of the node in question, a role 125 indicating whether the node is an initiator or a target, an IP address 126 and a port number 127. In the present embodiment, the role 125 is set with “1” when the node is an initiator that requests processing, and “2” when the node is a target that performs processing requested. Further, in the present embodiment, a node has one piece of node information 123. However, a node may have pieces of node information 123. As a case where a node has pieces of node information 123, it is possible to consider a case where one node has a plurality of storage names 124. In that case, the node information acquisition response transfer information 120 further includes an entry of the number of pieces of node information, for setting the number of pieces of node information owned by the node in question.

The node information acquisition unit 12 judges whether the above-mentioned node information acquisition response transfer information 120 has been received within a predetermined period (S105). In the case where node information acquisition response transfer information 120 has not been received within the predetermined period, or a predetermined negative response is received from a node (NO in S105), then the node information acquisition unit 12 judges that the node to which the node information acquisition request transfer information has been sent is not a node managed by this storage management system. And the node information acquisition unit 12 returns to the processing of S102.

In the case where the node information acquisition response transfer information 120 is received within the predetermined period (YES in S105), then the node information acquisition unit 12 examines whether the VLANID 94 of the switch information, for which the node information acquisition processing is being performed, exists in the group information table stored in the storing unit 16 (S106). In the case where the VLANID 94 of the node information acquired by the node information acquisition unit 12 does not exist in the group information table (NO in S106), then the group generation unit 13 adds a storage group of the VLANID 94 in question to the group information table 130 (S107). Namely, the group generation unit 13 generates an equivalent VLANID 131 and a storage group name 133 corresponding to the VLANID 94 in question, and adds the generated VLANID 131 and the storage group name 133 to the group information table 130.

FIG. 13 shows an example of the group information table 130. The group information table 130 is a table that associates a VLANID and a storage group name. The group information table 130 includes a group ID 131 for uniquely identifying a storage group, a VLANID 132 and a storage group name 133. In the present embodiment, the group generation unit 13 sets a sequential number in turn to the group ID, and a name consisting of “Group” added with a number set in the group ID 131 to the storage group name 133.

On the other hand, when the VLANID 94 in question already exists in the group information table 130 (YES in S106), or after the registration of the storage group of the VLANID 94 to the group information table 130 (S107), the node information acquisition unit 12 adds (saves) the switch information and the node information of the node in question to a storage management information table 140 shown in FIG. 14. Then, the node information acquisition unit 12 changes the status flag 95 in the switch information table 90 to “2” to indicate that the registration to the storage management information table 140 has been finished (S109). Then, the node information acquisition unit 12 returns to S102 to judges again whether the switch information table 90 has a piece of switch information for which the processing of acquiring the node information has not been performed. In the case where there does not exist a piece of switch information for which the node information acquisition processing has not been performed (NO in S102), then the node information acquisition unit 12 ends the node information acquisition processing and the group generation processing (S32 of FIG. 3).

FIG. 14 shows an example of the storage management information table 140. The storage management information table 140 includes a node ID 141 for identifying a node, a MAC address 142, an IP address 143, a VLANID 144, a storage name 145, a role 146, a port number 174, and a storage group name 148 for indicating a storage group to which the node in question belongs. When the role 146 is “1”, the node in question is an initiator, and when the role 146 is “2”, the node is a target.

The node information acquisition unit 12 sets the MAC address 142, the IP address 143 and the VLANID 144 with the respective values in the switch information table. Further, the node information acquisition unit 12 sets the storage name 145, the role 146 and the port number 147 with the respective values in the node information acquisition response transfer information 120. Further, referring to the group information table 130, the node information acquisition unit 12 specifies the storage group name 133 corresponding to the VLANID 144, and sets the specified storage group name 133 to the storage group name 148. Further, the node information acquisition unit 12 sets a unique number to the node ID 141.

Next, the registration processing (S33 of FIG. 3) of the storage name registration unit 14 will be described in detail.

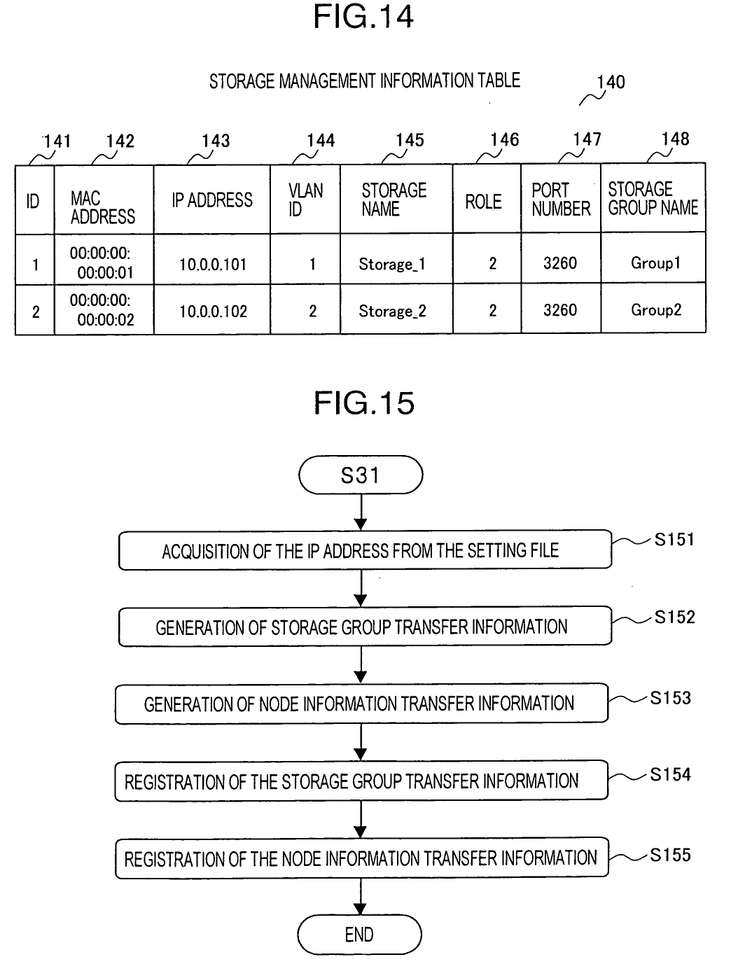

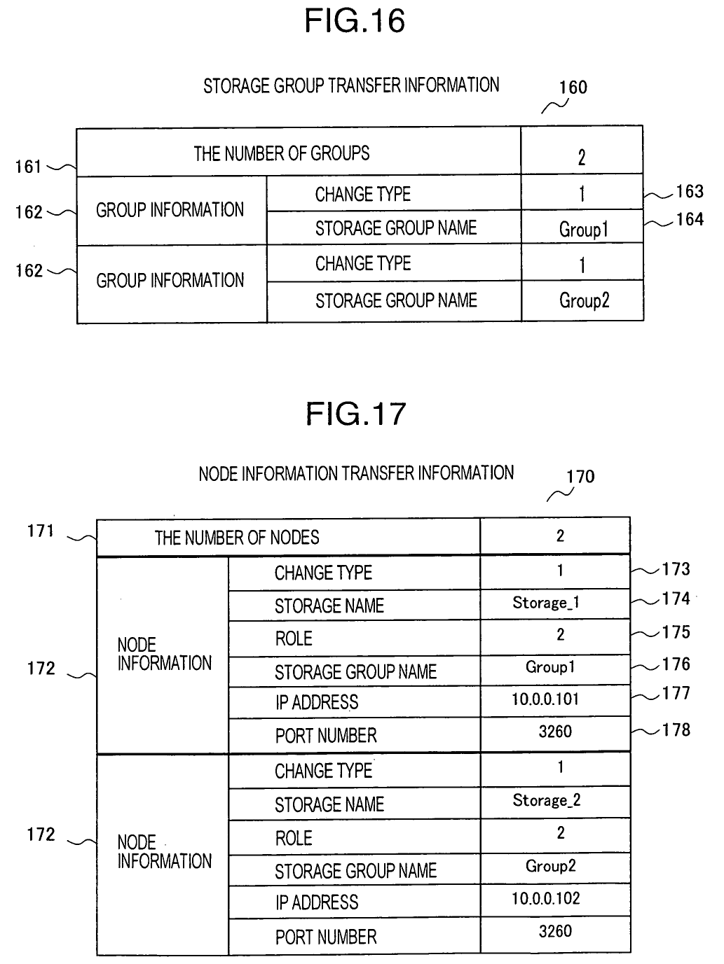

FIG. 15 is a flowchart showing the processing of registration at the storage name solving server 2. First, the storage name registration unit 14 acquires the IP address of the storage name solving server 2 as the destination of registration, from the setting file stored in the storing unit 16 (S151). Next, based on the group information table 130, the storage name registration unit 14 generates storage group transfer information shown in FIG. 16 (S152). Then, using the storage management information table 140, the storage name registration unit 14 generates node information transfer information shown in FIG. 17 (S153). Then, the storage name registration unit 14 registers (sends) the storage group transfer information to the storage name solving server 2 (S154). Next, the storage name registration unit 14 registers (sends) the node information transfer information to the storage name solving server 2 (S155).

FIG. 16 shows an example of the storage group transfer information 160. The storage group transfer information 160 includes the number of groups 161 indicating the number of storage groups to be registered, and pieces of group information 162, the number of which corresponds to the number set in the number of groups 161. Each piece of group information 162 includes a change type 163 and a storage group name 164. The change type 163 is set with a type of registration (update) of the storage group concerned. In the present embodiment, the change type 163 is set with “1” meaning addition of the storage group.

FIG. 17 shows an example of the node information transfer information 170. The node information transfer information 170 includes the number of nodes 171 indicating the number of nodes to be registered, and pieces of node information 172, the number of which corresponds to the number set in the number of nodes 171. Each piece of node information 172 includes a change type 173, a storage name 174, a role 175, a storage group name 176, an IP address 177, and a port number 178. The change type 173 is set with “1” similarly to the change type 163 of the storage group transfer information 160.

First, the registration unit 21 of the storage name solving server 2 receives the storage group transfer information 160. Then, based on the received storage group transfer information 160, the registration unit 21 updates a storage group name management table stored previously in the storing unit 23. Next, the registration unit 21 receives the node information transfer information 170. Then, based on the received node information transfer information 170, the registration unit 21 updates a storage name solving table stored previously in the storing unit 23. As a result, the registration unit 21 can register node information and the storage group to which the node information belongs, in the storing unit 23. In the case where the storing unit 23 does not store the storage group name management table and the storage name solving table previously, the registration unit 21 generates these tables anew.

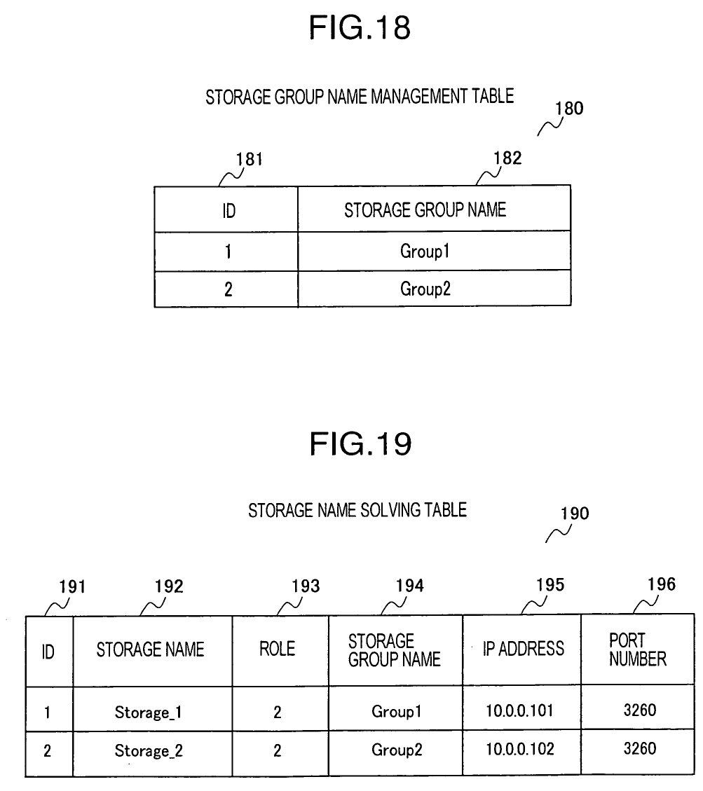

FIG. 18 shows an example of the storage group name management table 180. The storage group name management table 180 is a table for storing a name of a storage group to which each node information belongs. The storage group name management table 180 includes an ID 181 for identifying a storage group name and a storage group name 182. The registration unit 21 refers to the change type 163 in the storage group transfer information 160. Since the change type is “1” (addition), the registration unit 21 adds the storage group name 164 of each piece of group information 162 to the storage group name management table 180.

FIG. 19 shows an example of the storage name solving table 190. The storage name solving table is a table for indicating to which group each node belongs among the groups having the storage group names set in the storage group name management table 180. The storage name solving table 190 includes an ID 191 for identifying a node, a storage name 192, a role 193, a storage group name 194, an IP address 195, and a port number 196. The registration unit 21 refers to the change type 173 in the node information transfer information 170. Since the change type is “1” (addition), the registration unit 21 adds the various pieces of information 174-179 held in each piece of node information 172 to the storage name solving table 190.

Hereinabove, the first embodiment has been described.

In the present embodiment, the storage group registration server 1 can register storage groups classified similarly to VLANs previously set for a switch 3, at the storage name solving server 2. As a result, the storage name solving server 2 can classify nodes into some storage groups to manage those nodes. Further, when the storage name solving server 2 receives a request for finding a node, the storage name solving server 2 can find only nodes belonging to the same storage group as the node that has issued the request belongs to. Further, when storage groups that are generated based on the setting information of previously-set VLANs are automatically registered at the storage name solving server 2, it is possible to reduce work load on an administrator of the present storage management system. Further, it is possible to avoid mistake that may occur when the administrator manually sets storage groups. Further, it is possible to reduce work load in introducing the storage name solving server 2 anew.

### Second Embodiment

Now, will be described a second embodiment. The second embodiment relates to processing of updating the tables (See FIGS. 18 and 19) registered at the storage name solving server 2 when change information is received from a switch 3.

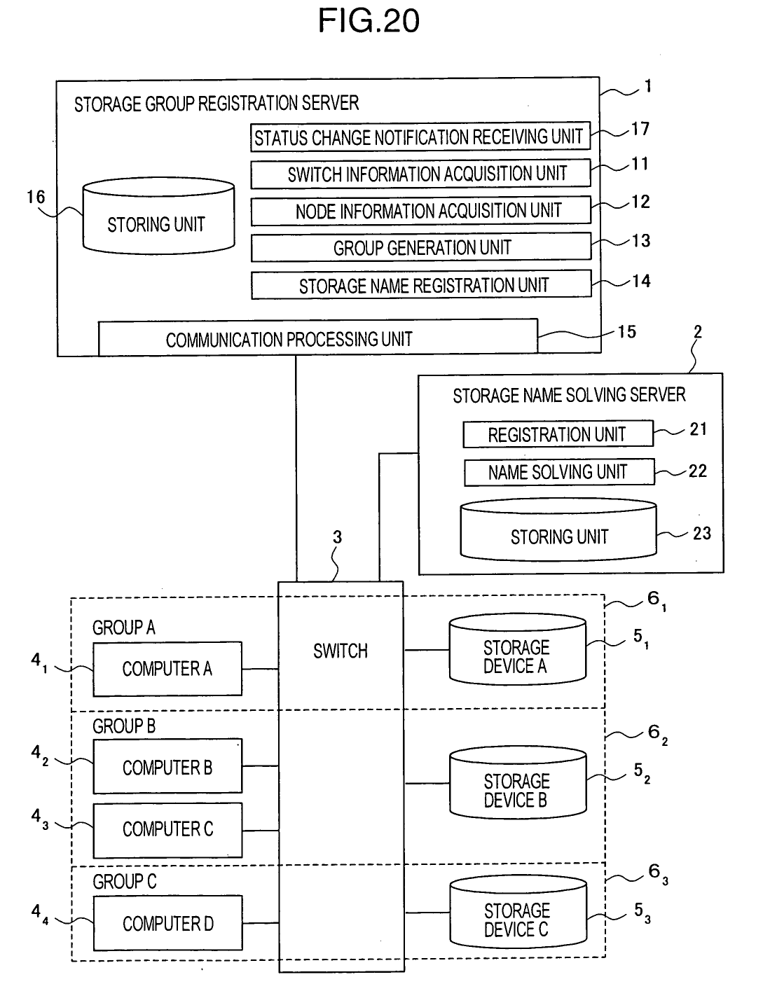

FIG. 20 is a schematic diagram showing a storage management system to which the second embodiment of the present invention is applied. As shown in the figure, the present system comprises a storage group registration server 1, a storage name solving server 2, at least one computer 4₁-4₄, at least one storage device 5₁-5₃, and at least one switch 3. The present system differs from the storage management system (FIG. 1) of the first embodiment in that the storage group registration server 1 further comprises a status change notification receiving unit 17. The status change notification receiving unit 17 receives a status change notification from the switch 3. In the present embodiment, when there occurs a change such as addition or deletion of a node or a change in the setting of VLANs, then the switch 3 sends status change notification transfer information 210 shown in FIG. 21 to the storage group registration server 1.

FIG. 21 shows an example of status change notification transfer information 210. Status change notification transfer information 210 includes a transfer information ID 211 for identifying the status change notification transfer information, the number of status change notifications 212, and status change notifications 212, the number of which corresponding to the number set in the number of status change notifications 212. Each status change notification 213 includes a change type 214, a MAC address 215, an IP address 216 and a VLANID 217. The change type 214 is set with “1” in the case of addition of a node, “2” in the case of deletion of a node, and “3” in the case of a change of a node.

Next, will be described an outline of processing in the storage group registration server 1 according to the present embodiment.

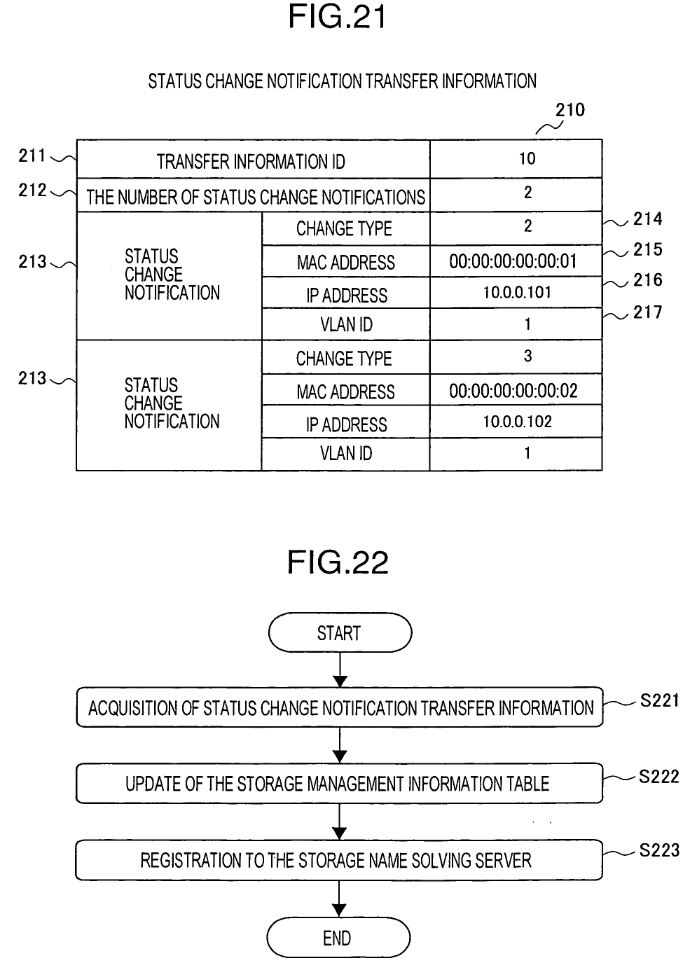

FIG. 22 is a flowchart showing an outline of processing in the storage group registration server 1. First, the status change notification receiving unit 17 of the storage group registration server 1 acquires status change notification transfer information 210 from the switch 3, to generate the below-mentioned status change notification preserving table (S221). Then, the node information acquisition unit 12 updates the storage management information table (FIG. 14) according to a change type in the status change notification preserving table (S222). Then, the storage name registration unit 14 registers change information at the storage name solving server 2 based on the status change notification preserving table and the storage management information table 140 (S223).

Next, the processing of acquiring the status change notification transfer information (S221 in FIG. 22) will be described in detail.

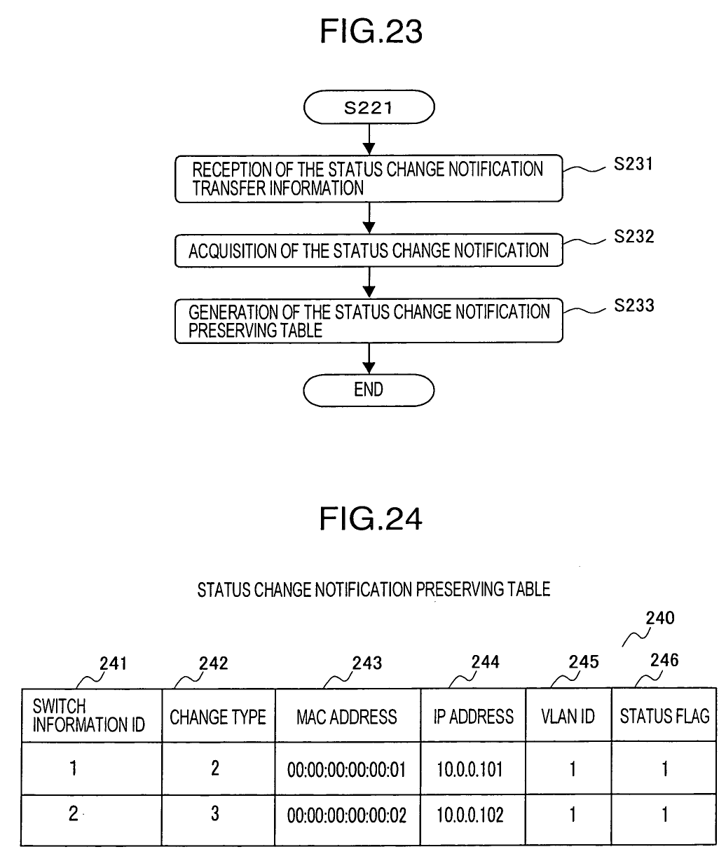

FIG. 23 is a flowchart for the status change notification receiving unit 17. The status change notification receiving unit 17 is in a waiting state until status change notification transfer information 210 (FIG. 21) is received. When status change notification transfer information 210 is received from the switch 3 (S231), the status change notification receiving unit 17 acquires each status change notification 213 included in the status change notification transfer information 210 (S232). Then, the status change notification receiving unit 17 generates a status change notification preserving table shown in FIG. 24 based on the acquired status change notifications 213, and stores the generated status change notification preserving table in the storing unit 16 (S233).

FIG. 24 shows an example of the status change notification preserving table 240. The status change notification preserving table 240 includes a switch information ID 241, a change type 242, a MAC address 243, an IP address 244, a VLANID 245, and a status flag 246. The status change notification preserving table 240 differs from the switch information table 90 (FIG. 9) described in the first embodiment in that the status change notification preserving table 240 includes the change type 242. The change type 242 is set with the same value as the change type 214 included in the status change notification transfer information 210. The status flag 246 is set with the following values depending on the value of the change type 214 of a status change notification 213. Namely, in the case where the change type 214 of a status change notification 213 is “1” (addition), the status change notification receiving unit 17 sets “0” to the status flag 246. Further, in the case where the change type 214 of a status change notification 213 is “2” (deletion) or “3” (change), the status change notification receiving unit 17 sets “1” to the status flag 246.

Next, the processing (S222 in FIG. 22) in the node information acquisition unit 12 will be described in detail.

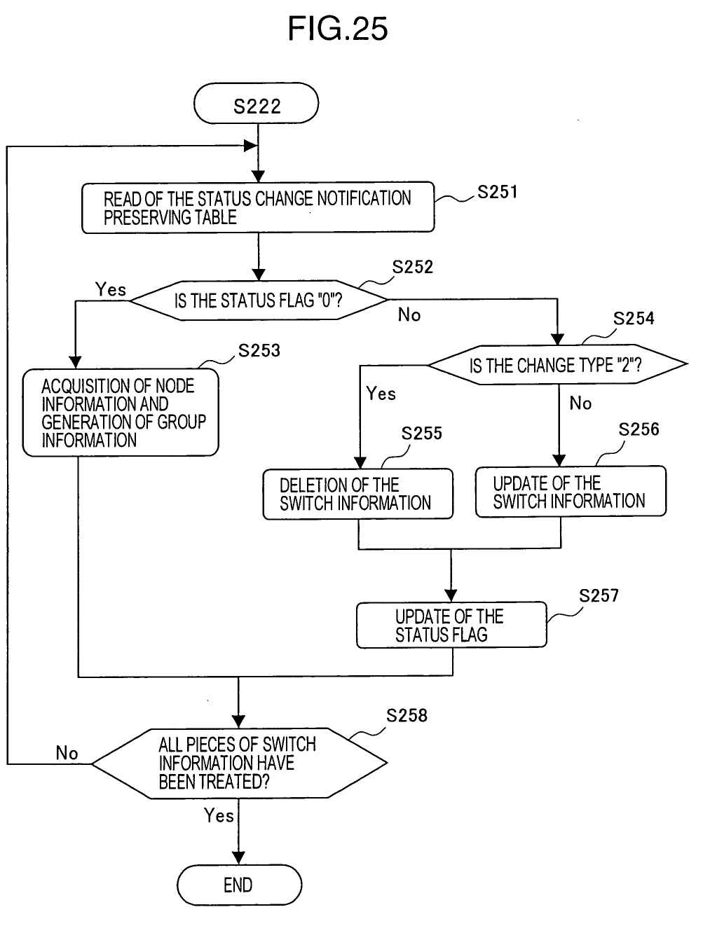

FIG. 25 is a flowchart showing processing in the node information acquisition unit 12. First, the node information acquisition unit 12 reads the status change notification preserving table 240 from the storing unit 16 (S251). Then, for each piece of switch information (record) in the status change notification preserving table 240, the node information acquisition unit 12 judges whether the status flag is “0” or not (S252). In the case where the status flag is “0” (i.e., the change type 242 is “1” (addition)) (YES in S252), then the node information acquisition unit 12 performs processing similar to the node information acquisition processing and the group information generation processing in the first embodiment (See FIG. 10) (S253).

On the other hand, in the case where the status flag is “1” (i.e., the change type 242 is “2” (deletion) or “3” (change)) (NO in S252), then the node information acquisition unit 12 judges whether the change type is set with “2” (deletion) or not (S254). In the case where the change type is “2” (deletion) (YES in S254), then the node information acquisition unit 12 deletes the node (record) having the same MAC address as the switch information in question from the storage management information table 140 (FIG. 14) (S255). At the time of the deletion from the storage management information table 140, the node information acquisition unit 12 sets the node (record) in question with a deletion flag not shown.

In the case where the change type is other than “2”, i.e., the change type is “3” (change) (NO in S254), the node information acquisition unit 12 specifies a node (record) having the same MAC address as the switch information in question, in the storage management information table 140, and updates the specified node (record) (S256). Namely, in the storage management information table 140, the node information acquisition unit 12 updates the IP address 143 or the VLANID 144 of the node (record) in question to the value in the status change notification preserving table 240. And, the node information acquisition unit 12 changes the status flag 246 in the status change notification preserving table to “2” (S257).

Next, the node information acquisition unit 12 judges whether all pieces of switch information in the status change notification preserving table 240 have been treated (S258). In the case where there exists an untreated piece of switch information (NO in S258), then the node information acquisition unit 12 returns to S251 to perform the processing on that untreated piece of switch information from S251 downward. In the case where all pieces of switch information have been treated (YES in S258), then the node information acquisition unit 12 ends the present processing.

Next, the registration processing (S223 in FIG. 22) in the storage name registration unit 14 will be described in detail.

The storage name registration unit 14 performs processing similar to the first embodiment (See FIG. 15), to register change information at the storage name solving server 2. However, the processing in the storage name registration unit 14 in the present embodiment differs from the processing shown in FIG. 15 of the first embodiment in the following points.

Namely, in the processing of S153, the storage name registration unit 14 generates node information transfer information (FIG. 17) based on the status change notification preserving table 240 (FIG. 24). In detail, using the MAC address 243 in the status change notification preserving table 240 as a search key, the storage name registration unit 14 specifies a node (record) having the MAC address 142 of the same value as the MAC address 243, in the storage management information table 140 updated in the node information acquisition processing (S222). Then, in the case where the change type 242 of the status change notification preserving table 240 is “1” (addition), then the storage name registration unit 14 sets “1” to the change type 173, and generates node information 172 based on the various pieces of information of the specified node (record). In the case where the change type 242 of the status change notification preserving table 240 is “2” (deletion), then the storage name registration unit 14 sets “2” to the change type 173, and generates node information 172 based on the various pieces of information of the specified node (record). Further, in the case where the change type 242 of the status change notification preserving table 240 is “3” (change), then the storage name registration unit 14 sets “3” to the change type 173, and generates node information 172 based on the various pieces of information of the specified node (record). Thus, the storage name registration unit 14 generates node information 172 for all pieces of switch information in the status change notification preserving table 240 to generate node information transfer information 170.

Then, the registration unit 21 of the storage name solving server 2 receives the node information transfer information 170. And, depending on the change types 173 in the node information transfer information 170, the registration unit 21 updates the storage name solving table previously stored in the storing unit 23.

Hereinabove, the second embodiment has been described.

In the present embodiment, when the setting information of the switch 3 is changed, the storage group registration server 1 receives change information from the switch 3 and sends the change information to the storage name solving server 2. As a result, it is possible to reflect in real time the change in the VLAN setting information held by the switch 3 onto the tables (See FIGS. 18 and 19) of the storage name solving server 2.

The present invention is not limited to the above-described embodiments, and can be varied within the gist of the invention.

For example, the storage group registration server 1 of the second embodiment has both the status change notification receiving unit 17 and the switch information acquisition unit 11. However, the storage group registration server 1 may have the status change notification receiving unit 17 only, without having the switch information acquisition unit 11. In that case, after the storage name management table 180 and the storage name solving table 190 are once registered in the storing unit 23 of the storage name solving server 2, the storage group registration server 1 receives the change information from the switch 3 and updates information in the tables 80 and 190.

1. A storage group setting method for registering storage groups at a management device, said method being performed by an information processing device connected to a network system comprising one or more network devices, one or more nodes connected to said network devices, and a management device for managing said nodes by classifying said nodes into storage groups, said method comprising:
a group information acquisition step in which group information for identifying respective groups to which nodes belong is acquired from each of said network devices each being previously set with said group information, and the acquired group information is stored in a storing device owned by said information processing device;
a node information acquisition step in which, from each of said nodes, node information required for connecting the node in question to said network is acquired, and the acquired node information is stored in said storing device;
a group generation step in which said storage groups are generated based on said group information stored in said storing device; and
a registration step in which said storage groups generated and said node information stored in said storing device are registered at said management device.

2. A storage group setting method according to claim 1, wherein:
said group generation step generates the same storage groups as in the group information set to said network devices.

3. A storage group setting method according to claim 1, wherein:
in said registration step, said storage groups are registered before said node information is registered.

4. A storage group setting method according to claim 1, wherein:
in said group information acquisition step, a request message for requesting group information is sent to each of said network devices, and said group information included in each response message to said request message is acquired.

5. A storage group setting method according to claim 1, further comprising:
a change notification receiving step in which change notification information on a change of said group information is received from each of said network devices, and the received change notification information is stored in said storing device.

6. A storage group setting method according to claim 1, wherein:
in said group information acquisition step, when duplicate group information is acquired from a network device, said duplicate group information is not stored in said storing device.

7. A storage group setting method according to claim 1, wherein:
in said node information acquisition step, a request message requesting node information is sent to each of said nodes, and when a response message to said request message is not received from some node, it is judged that said node is out of management by said management device.

8. A storage group setting method according to claim 1, wherein:
said change notification information includes a change type of group information; and
when the change type of said change notification information indicate a change or deletion, then said node information acquisition step does not acquire node information of a node having said change type.

9. A storage group registration device for registering storage groups at a management device, said storing group registration device connected to a network system comprising one or more network devices, one or more nodes connected to said network devices and said management device for managing said nodes by classifying said nodes into storage groups, wherein:
said storage group registration device comprises:
a group information acquisition module for acquiring group information for identifying respective groups to which nodes belong from each of said network device each being previously set with said group information;
a node information acquisition module for acquiring, from each of said nodes, node information required for connecting the node in question to said network from each of said nodes;
a group generation module for generating said storage groups based on said group information; and
a registration module for registering said storage groups generated and said node information at said management device.

10. A storage group setting program for setting storage groups at a management device, said program being executed in an information processing device, said information processing device connected to a network system comprising one or more network devices, one or more nodes connected to said network devices, and said management device for managing said nodes by classifying said nodes into said storage groups, said program comprising:
a group information acquisition step in which group information for identifying respective groups to which nodes belong is acquired from each of said network devices each being previously set with said group information, and the acquired group information is stored in a storing device owned by said information processing device;
a node information acquisition step in which, from each of said nodes, node information required for connecting the node in question to said network is acquired, and the acquired node information is stored in said storing device;
a group generation step in which said storage groups are generated based on said group information stored in said storing device; and
a registration step in which said storage groups generated and said node information stored in said storing device are registered at said management device.
